(19) United States
(12) Patent Application Publication
(10) Pub. No.: US 2009/0072559 A1
(43) Pub. Date: Mar. 19, 2009

(54) PET WASTE COLLECTION DEVICE

(76) Inventor: Sheree Wilkerson, Milwaukee, WI (US)

Correspondence Address: NW-IP-LAW, 6039 E. Grant RD., Tucson, AZ, 85712, US

(21) Appl. No.: 11/854,908

(22) Filed: Sep. 13, 2007

(51) Int. Cl. A01K 29/00

(52) U.S. Cl. 294/1.4

(57) ABSTRACT

A collector, comprising: a handle, a collector portion attached to the handle, at least one attachment means attached to the handle; and a disposable bag, wherein the collector portion further comprises a front portion, a back portion and wherein the at least one attachment means further comprises a releasable end.

### FIELD OF THE INVENTION

The present invention is directed to a collector for collecting waste, e.g., animal waste. The collector includes a handle, a collector portion, attachment means, and a disposable sack. A person can use the collector to scoop up waste without having to bend over, thereby causing minimal mess.

### BACKGROUND OF THE INVENTION

Well-designed and convenient waste removal apparatus is a basic necessity in every day life. For example, persons with animals often wish to have an easy way to collect and dispose of the waste, e.g., animal waste. They also may wish to have a way to collect the waste without having to bend over to pick the waste up. However, most persons who want an easy and clean way to collect their animal's waste use plastic bags to pick up the waste. This method requires the person to bend over and collect the waste with just a thin plastic bag between their hand and the waste. One problem with this method is the likelihood that the plastic bag may tear open and the person comes in contact with the animal's waste. Another problem with this method is the difficulty in bending over to collect the waste. Another method that people use to collect animal's waste is a scoop. However, if the scoop does not have a handle, there is a difficulty in bending over to scoop up the waste. Another problem is the mess the waste makes within the scoop.

Therefore, there is a need for an improved collector for collecting animal waste, where a person can grasp the collector's handle and collect the waste in the collector into a disposable bag without bending over and then release the bag from the collector to throw away.

### BRIEF DESCRIPTION OF THE DRAWINGS

FIG. 1 is an illustration of a collector according to the invention including a handle, a collector portion, a first attachment means, and a disposable bag.

FIG. 2 is a side view illustration of a scoop according to the invention including a handle, a collector portion, a first attachment means, a second attachment means, and a disposable bag.

FIG. 3 shows the collector of FIG. 1 in combination with a releasable flat collector.

### DESCRIPTION OF PREFERRED EMBODIMENTS

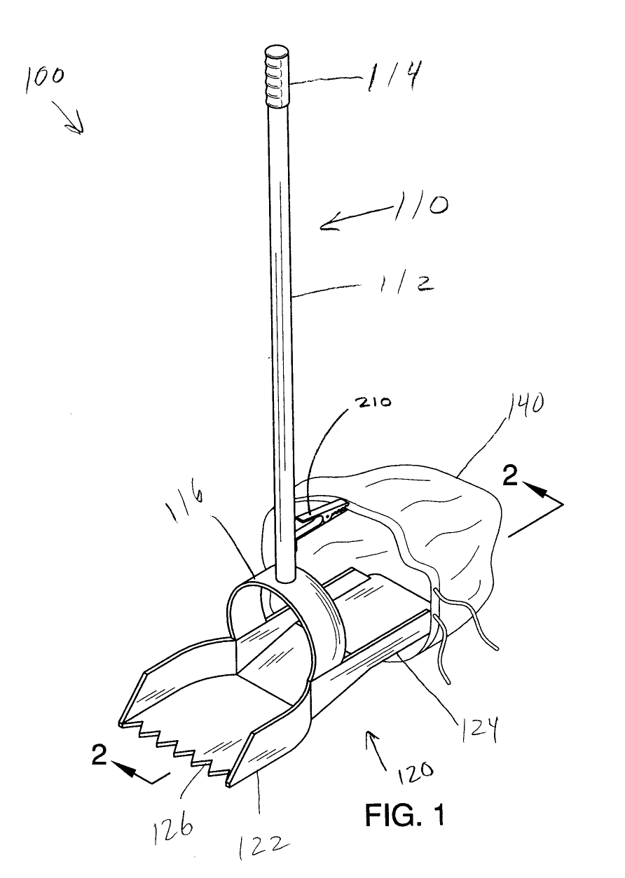

Referring now to FIG. 1, collector 100 comprises handle 110, collector portion 120, a first releasable attachment means 210, and disposable bag 140. In the illustrated embodiment of FIG. 1, handle 110 comprises a tubular member 112, a hand grip 114, and a base attachment means 116. In some embodiments, the base attachment means comprises an arch. In some embodiments, the base attachment means comprises a U-shaped or C-shaped member, wherein the free ends of the U-shaped or C-shaped member attach to the collector portion. In certain embodiments, handle 110 comprises a solid member 112 having a circular cross-section. In the illustrated embodiment of FIG. 1, collector portion 120 comprises front portion 122, back portion 124, and teeth 126. In the illustrated embodiment of FIG. 1, the first releasable attachment means 210 comprises a standard alligator clip. In the illustrated embodiment of FIG. 1, disposable bag 140 comprises a variety of sizes. In the illustrated embodiment of FIG. 1, first releasable attachment means 210 is attached to handle 110 by conventional attachment means such as welding, plastic welding, mechanical fasteners, and the like. In the illustrated embodiment of FIG. 1, base attachment means 116 is attached to back portion 124 by conventional attachment means such as welding, plastic welding, mechanical fasteners, and the like. In the illustrated embodiment of FIG. 1, base attachment means 116 comprises a half-circle shape that allows the animal's waste to pass underneath and into disposable bag 140.

When a user wishes to scoop up an animal's waste, the user grasps handle 110 and pushes front portion 122 of collector portion 120 along the ground behind the waste. As the teeth come in contact with the waste, the waste is pushed onto the front portion 122 of the collector 100. As more waste is collected, the waste is pushed into disposable bag 140. When disposable bag 140 is filled with waste, the user may release the disposable bag 140 from releasable attachment means and discard the bag. The user may then attach another disposable bag 140 onto releasable attachment means.

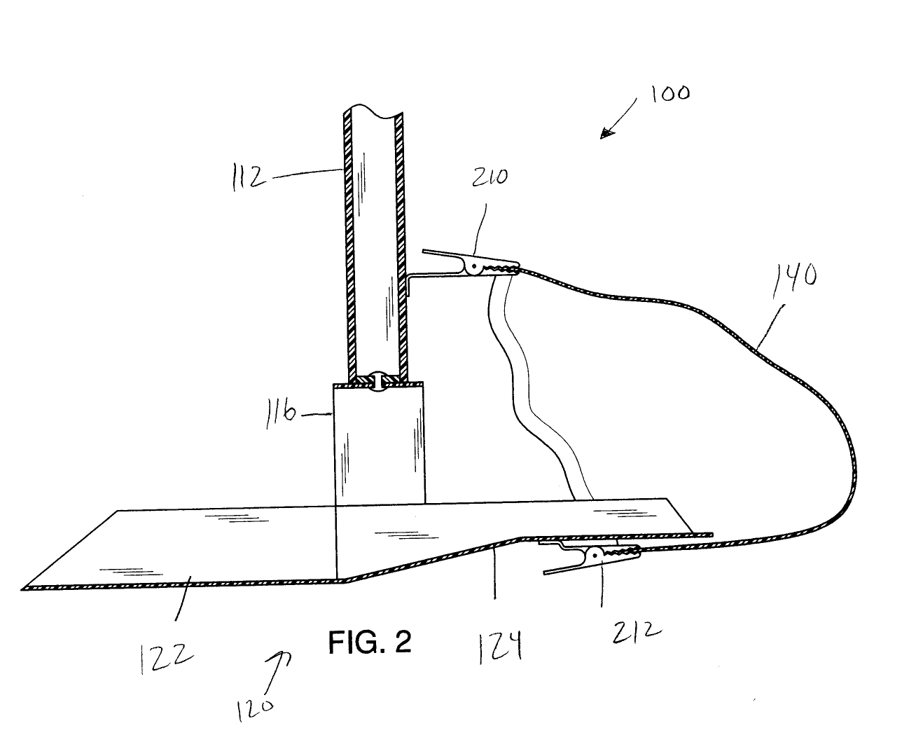

Referring now to FIG. 2, a side view is shown of collector 100 comprising tubular member 112, collector portion 120, first releasable attachment means 210, and disposable bag 140. In the illustrated embodiment of FIG. 2, a releasable attachment means comprises first releasable attachment means 210 and second releasable attachment means 212. Second releasable attachment means 212 is attached to back portion 124 of collector portion 120 by conventional attachment means such as welding, plastic welding, mechanical fasteners, and the like. In some embodiments, the underside of the back portion 124 is slightly elevated relative to the underside of the front portion, so that the second releasable attachment means 212 can fit underneath the back portion. First releasable attachment means 210 and second releasable attachment means 212 allow for disposable bag 140 to stay attached to the handle 112 and the back portion 124 respectively.

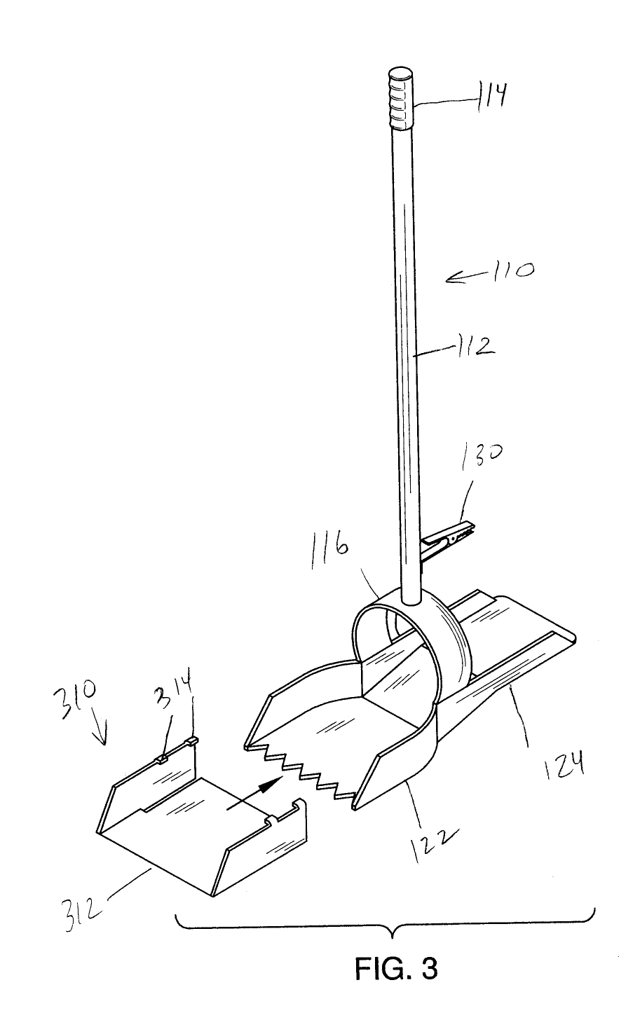

Referring now to FIG. 3, collector 100 is shown comprising a releasable flat collector 310. In the illustrated embodiment of FIG. 3, releasable flat collector 310 comprises collector portion 312 and at least one releasable attachment means 314. Releasable flat collector 310 allows for a user to easily scoop up an animal's waste from a hard surface. The user may slide the back of releasable flat collector 310 onto front portion 122 and lock them together by the releasable attachment means 314. The user may then collect waste as described above. When the user wishes to use teeth 126, they may pull releasable flat collector 310 and collector portion 120 in opposite directions to release releasable flat collector 310 from collector portion 120.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

1. A collector, comprising:
a handle;
a collector portion attached to a base attachment means, wherein the base attachment means attaches to the handle; the collector portion further comprises a front portion and a back portion;
a first alligator clip comprising a releasable end attached to the handle, wherein the first alligator clip is effective for attaching a bag; and
a second alligator clip comprising a releasable end attached to an underside of the back portion, the second alligator clip is effective for attaching the bag.

2. The collector of claim 1, wherein the handle further comprises a hand grip.

3. The collector of claim 1, wherein the front portion further comprises a set of teeth disposed on a front edge of the front portion.

4. The collector of claim 1, wherein the collector portion further comprises a releasable flat collector.

5. The collector of claim 3, wherein the front portion further comprises a releasable flat collector slidably attached to an outer edge of the front portion.
